(19) United States
(12) Patent Application Publication
(10) Pub. No.: US 2006/0215224 A1
(43) Pub. Date: Sep. 28, 2006

(54) Document management system and scan template used in document management system

(75) Inventor: Keigo Matsumoto, Tokyo (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/264,232

(22) Filed: Oct. 31, 2005

(30) Foreign Application Priority Data
Mar. 23, 2005 (JP) 2005-084283

(51) Int. Cl. G06K 15/00

(52) U.S. Cl. 358/1.18; 358/402

(57) ABSTRACT

A document management system includes a scanning device for reading and converting a document image of a contract document, an approval document, a project proposal, a receipt or the like into electronic form to generated scanned document data; a time-stamping server for adding a time stamp to the scanned document data; a certificate server for adding an electronic signature to the scanned document data; a document management server for receiving and storing the time-stamped and electronically signed scanned document data; and a control panel for controlling scanning operation of the scanning device. A scan template for configuring scan settings for the scanning device is created on the control panel.

### BACKGROUND OF THE INVENTION

1. Field of the Invention

The present invention relates to document creation and storage techniques in which a document required to be kept is converted into electronic form, given a time stamp, electronically certificated, and thus stored. In particular, the present invention relates to a document management system and a scan template used in the document management system that allow the creation, certificate, and storage of scanned document data to be performed by simple and efficient document creation and management operations.

2. Description of the Related Art

Image reading techniques for reading images in a document are applied, for example, to electrophotographic multi-functional peripherals (MFPs) and scanning apparatuses, such as image scanners. There are document management systems that allow images read and converted by such a scanning apparatus into electronic form to be sent to and stored on a document management server or on a PC.

An example of known document management systems of this type is described in JP-A 2001-285534.

This document management system includes an MFP that serves as an image forming apparatus for reading and converting a document image into electronic form. The MFP includes a scanning device that creates scanned document data, including graphics data, from a document image. The scanning device is connected to a LAN and public communication network, and thus inputs and outputs information.

An operating unit used to control the scanning device in the MFP provides a template for defining the resolution of scanned document data, color modes (color or monochrome), scanning sizes, and the like. This template simplifies the process of creating scanned document data from a document image, and eliminates the necessity for scan settings to be configured every time scanned document data is to be created.

To store the scanned document data as an electronic file in a particular location, a user uses the operating unit, every time after the scanning device of the MFP creates the scanned document data, to specify the location, and sends and stores the scanned document data in the specified location.

In such a known document management system, a scanning device of an MFP reads and converts a document image into electronic form to create scanned document data, stores the created scanned document data in a memory of the scanning device, or sends the scanned document data to a particular location to save it therein.

However, additional operations are required for comparing the scanned document data created by the scanning device with the original document image to determine whether or not the scanning has been properly performed, for electronically certificating the scanned document data, and for adding a time stamp thereto.

### SUMMARY OF THE INVENTION

The present invention has been achieved in view of the circumstances described above. An object of the present invention is to provide a document management system and a scan template included in the system that allow efficient execution of a series of document management operations involving the creation, certificate, and storage of a document in electronic form, by configuring the scan settings of the scanning device just one time.

Another object of the present invention is to provide a document management system and a scan template included in the system that simplify document management operations involving the creation of scanned document data in electronic form, the addition of electronic certificate and time stamp to the scanned document data, and the storage of the scanned document data, and thus reduce time required for the operations, by simply reflecting scan settings in a scan template.

To solve the problems described above, in an aspect of the present invention, a document management system includes a scanning device for reading and converting a document image of a contract document, an approval document, a project proposal, a receipt or the like into electronic form to generated scanned document data; a time-stamping server for adding a time stamp to the scanned document data; a certificate server for adding an electronic signature to the scanned document data; a document management server for receiving and storing the time-stamped and electronically signed scanned document data; and a control panel for controlling scanning operation of the scanning device. A scan template for configuring scan settings for the scanning device is created on the control panel.

In another aspect of the present invention, a scan template is created on a control panel of a scanning device reflects the operation of a plurality of scan buttons, and includes setting items required for converting a document image into electronic form.

The document management system of the present invention and the scan template included in the system have an advantage in that they allow efficient execution of a series of document management operations involving the creation, certificate, and storage of a document in electronic form, by configuring the scan settings of the scanning device just one time.

Another advantage of the document management system and the scan template included in the system is that they simplify document management operations involving the creation of scanned document data in electronic form, the addition of electronic certificate and time stamp to the scanned document data, and the storage of the scanned document data, and thus reduce time required for the operations, by simply reflecting scan settings in the scan template.

### BRIEF DESCRIPTION OF THE DRAWINGS

FIG. 1 shows the system structure of a document management system according to an embodiment of the present invention.

FIG. 2 shows the structure of a controller for controlling a scanning device of an MFP included in the document management system.

FIG. 3 shows an example of a scan template provided on a control panel for controlling the scanning device of the MFP.

FIG. 4 is a flowchart showing a process when the document management system is used to cause the scanning device to perform scanning operation.

### DESCRIPTION OF THE PREFERRED EMBODIMENTS

Embodiments of the present invention will now be described with reference to the attached drawings.

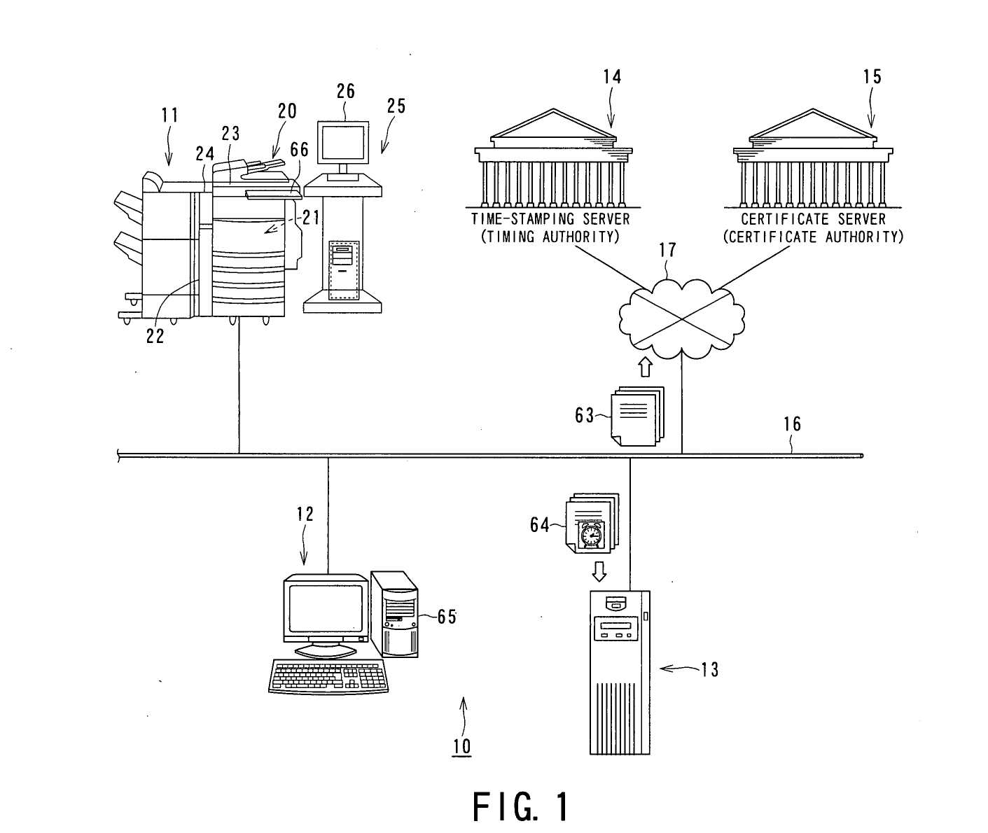

FIG. 1 shows the system structure of a document management system according to an embodiment of the present invention. A document management system 10 includes one or a plurality of MFPs 11, a client PC 12, a document management server 13, a time-stamping server 14 serving as a timing authority, and an electronic certificate server 15 serving as a certificate authority that are connected through a system bus 16 via a LAN, or via a communication network 17, such as the Internet.

Each MFP 11 includes a scanning device 20 and a printing device 21 in the upper and lower parts of a main casing 22, respectively. The scanning device 20 reads and converts a document image into electronic form, while the printing device 21 prints the scanned document data, including graphics data, on a paper medium. A control panel 23 for controlling the entire MFP 11 is provided on top of the main casing 22. The scanning device 20 and the printing device 21 operate independently or in conjunction with each other by operating the control panel 23. The MFP 11 may be replaced with a scanning apparatus, such as an image scanner.

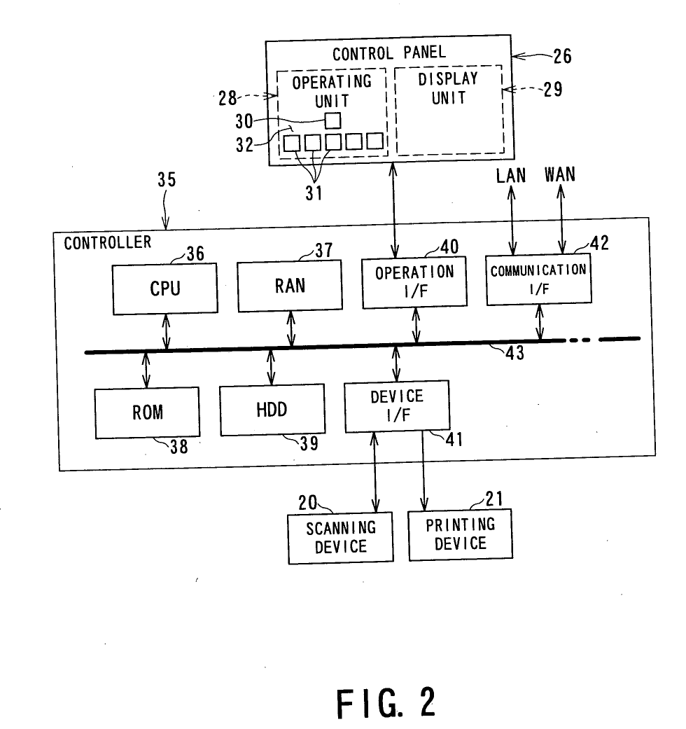

A main body 24 of the MFP 11 is provided with a PC 25 for communicating with the MFP 11. The PC 25 includes a control panel 26 of a touch-panel type. As shown in FIG. 2, the control panel 26 includes an operating unit 28 constituting an input section, and a display unit 29 constituting an output section, and serves as a user interface with the main body 24. The display unit 29 is a liquid crystal display or an organic EL display. The operating unit 28 provides a certificate system 30, a plurality of scan buttons 31, a touch panel 32, and the like.

The main body 24 of the MFP 11 includes a controller 35 for controlling the startup of the entire MFP 11. The controller 35 controls the operation of the scanning device 20 and printing device 21 in response to the operation of the control panel 26.

The controller 35 includes a CPU (MPU) 36 serving as a central processing control unit for controlling the entire MFP 11, a RAM 37 serving as a work memory used by the CPU 36 and as a temporary memory for scanned document data (image data), a ROM 38 on which an operation program of the MFP 11 is stored, a hard disk 39, an operation interface (I/F) 40 connected to the control panel 26, a device I/F 41 connected to the scanning device 20 and to the printing device 21, and a communication I/F 42 connected to the system bus 16 and to the communication network 17, which are all connected via a control bus 43.

System software to be executed by the CPU 36, scan settings configured by a user, scanned document data, and the like are stored on the hard disk 39. The operation I/F 40 is an interface with the control panel 26. The operation I/F 40 outputs, to the control panel 26, image data to be displayed on the control panel 26, while sending information entered by the user from the operating unit 28 to the CPU 36 of the controller 35.

The communication I/F 42 is an interface between the scanning device 20 of the MFP 11, and the LAN and a communication network (WAN). The device I/F 41 is an interface between the CPU 36 of the controller 35, and the scanning device 20 and the printing device 21 serving as input/output devices for scanned document data.

The plurality of scan buttons 31 on the control panel 26 for controlling the MFP 11 are used to create a scan template 45. The scan template 45 is used to define items necessary for storing documents in accordance with company's (user's) rules and legal regulations.

The scan template 45 defines scan settings, filing settings, optical character recognition (OCR) settings, security settings, or the like that are required for converting images of paper documents into electronic form.

The control panel 26 (23) of the MFP 11 provides scan buttons 31 that reflect the scan template 45. Settings for storing documents are configured in the scan template 45 by using the scan buttons 31. This reduces time required for the user to perform a series of operations that involve the creation of scanned document data, electronic certificate, time stamping, and the storing of scanned document data files.

The operating unit 28 of the control panel 26 provides the electronic certificate system 30 that is used to specify users who can use the MFP 11 and to restrict access to the MFP 11 by the other users. The users who are permitted to use the MFP 11 are pre-registered in the certificate system 30. Only the permitted users and an administrator who has configured the certificate settings have access to the MFP 11. The certificate system 30 is for specifying users who can use the MFP 11. Users who are not pre-registered in the certificate system 30 cannot use the MFP 11.

Moreover, the use of the MFP 11 varies among the permitted users. For example, users A and B are permitted to use the scanning device 20 of the MFP 11 only, while a user C can use both the scanning device 20 and printing device 21 of the MFP 11, and a user D can use not only the scanning device 20 and printing device 21 of the MFP 11, but also the time-stamping server 14 and electronic certificate server 15 for electronic certificate and time stamping. Specifying users who can access the MFP 11 and the extent to which each user can use the MFP 11 thus clarify the individual users' responsibilities in using the MFP 11.

As described above, the operating unit 28 of the control panel 26 provides the certificate system 30 for specifying users who can access the MFP 11 and the extent to which each user can use the MFP 11. Since the certificate system 30 thus gives permission for the use of the MFP 11 and defines the range of use, a problem of easy and unauthorized use of a time stamp and electronic signature can be avoided. Examples of certificate methods used in the certificate system 30 to certificate individual users include biometrics such as finger scans, password certificate, and contact-type card certificate through ID cards or the like.

Pressing the plurality of scan buttons 31 on the control panel 26 causes the scan template 45 of a touch-panel type to be displayed. The scan template 45 provides items of scan settings, filing settings, OCR settings, security settings, or the like.

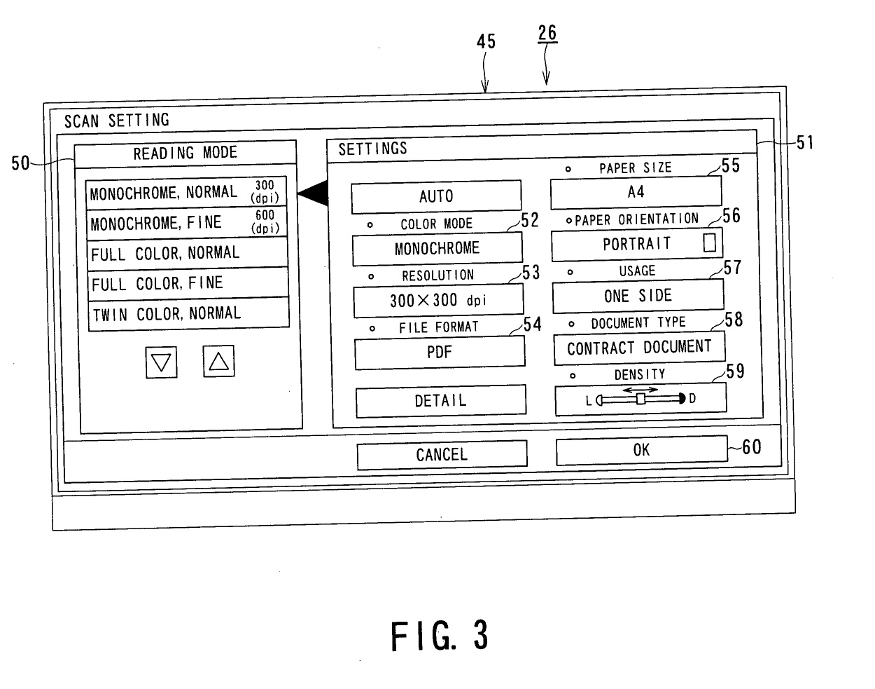

FIG. 3 shows the scan template 45 for scan setting. For example, if “MONOCHROME, NORMAL 300 (dpi)” is selected from the options of reading mode 50, a window showing settings 51 corresponding to “MONOCHROME, NORMAL 300 (dpi)” appears. The settings 51 include color mode 52, resolution 53, file format 54, paper size 55, paper orientation 56, usage 57, document type 58, and density 59. The setting options currently displayed can be changed by pressing operation. Pressing an OK button 60 on the scan template 45 terminates the scan setting operation.

The scan template 45 also provides filing settings, OCR settings, security settings, and the like, as well as the scan settings described above. The filing settings include a location for saving document data files, electronic certificate (signature) settings, time stamp settings, and the like.

The OCR settings include the resolution of scanned document data, language settings, such as Japanese, English, and Chinese, OCR area settings, and the like.

The security settings include encryption settings, password settings, access permission settings, and the like for ensuring the security of scanned document data.

Each scan template 45 displayed on the control panel 26 may represent a single setting item, or a plurality of setting items.

The control panel 23 on the main body 24 of the MFP 11 may have the same structure and functions of those of the control panel 26 on the PC 25. If the control panel 23 is provided on the MFP 11, the PC 25 and the control panel 26 thereon may be removed.

The operation of the document management system 10 will now be described.

Examples of documents required to be kept under the company's (client's) rules and legal regulations include contract documents, approval documents, project proposals, and receipts. The MFP 11 converts images of these documents into electronic form to create scanned document data 63, including graphics data.

A hash value for the purpose of data transmission is calculated by the CPU 36 of the controller 35 on the basis of the created scanned document data 63, and sent via the communication network 17 to the time-stamping server 14 and electronic certificate server 15. The hash value of the scanned document data 63 is given a time stamp and electronic certificate by the time-stamping server 14 and the electronic certificate server 15, respectively.

A time stamp is intended to certify the time certificate of the scanned document data 63, while electronic certificate is intended to certify under whose responsibility the certificate of the existence of the scanned document data 63 is issued. The individual users to be certified are pre-registered in the time-stamping server and certificate server.

After being given a time stamp and electronic certificate by the time-stamping server 14 and electronic certificate server 15, respectively, the hash value of the scanned document data 63 is sent back to the controller 35 of the MFP 11, and attached to and combined with the scanned document data 63.

Then, time-stamped/electronically-signed (certificated) scanned document data 64 is sent from the controller 35 of the MFP 11 to the client PC 12, registered as an image document on a hard disk 65 of the client PC 12, given a retrieval key, and stored on the hard disk 65.

The time-stamped/electronically-signed scanned document data 64 with the retrieval key is sent to the document management server 13 automatically or by operating the keyboard of the client PC 12, and stored on the hard disk of the document management server 13. When the time-stamped/electronically-signed scanned document data 64 is stored, its time stamp and electronic signature are verified and a search function is added to the document management server 13.

In the document management system 10 shown in FIG. 1, only users pre-registered in the certificate system 30 (FIG. 2) and given permission have access to the MFP 11. However, the users permitted to use the MFP 11 may not have access to the time-stamping server 14 and electronic certificate server 15 depending on the settings of the scan template 45. Only users permitted to use time stamps and electronic certificate have access to the time-stamping server 14 and electronic certificate server 15.

Permitted users pre-registered in the time-stamping server 14 and electronic certificate server 15 can operate the scanning device 20 and printing device 21 of the MFP 11 by operating the control panel 26 of the PC 25.

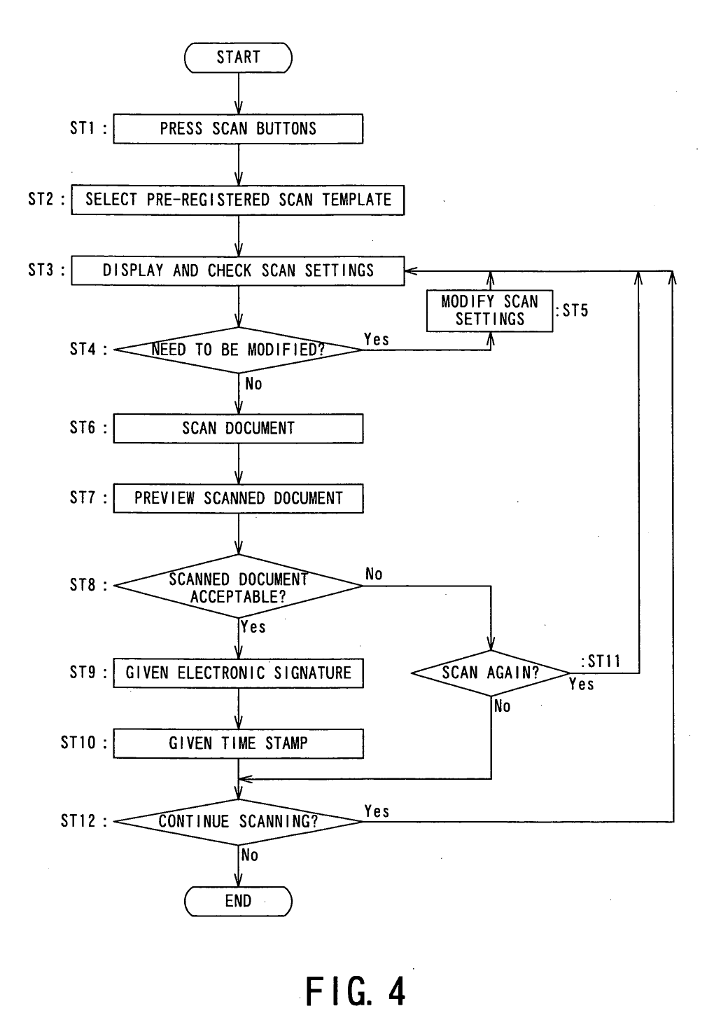

In this case, first, a user presses the scan buttons 31 of the operating unit 28 (step ST1 in FIG. 4). Pressing the scan buttons 31 allows scanning to be performed as specified in each scan template 45. To modify pre-registered scan settings, a user selects a scan template 45 corresponding to the scan settings to be modified (e.g. settings to accommodate the requirements of ministries or to meet company rules) (in step ST2), and modifies only a specific setting item in the selected scan template 45.

After the modification, the MFP 11 operates according to the modified settings. The settings, including the modified settings, of the MFP 11 are displayed on the display unit 29 in step ST3 and can be visually checked before the scanning device 20 performs scanning operations.

As described above, a user can check settings in the scan template 45 before the scanning device 20 performs scanning operations according to the settings in the scan template 45. Since the scan template 45 allows a single user to configure multiple settings, the user configures selected settings before the scanning device 20 performs scanning operations.

If settings displayed on the display unit 29 are to be modified (“Yes” in step ST4), the settings are modified (step ST5) and the process returns to step ST3. The modification of settings here means, for example, the change of language settings from Japanese to English, and the change of paper (receipt) size, encryption algorithm, password, color mode, paper usage, and document type.

On the other hand, if no modification of settings is required (step ST4), a document is placed on the scanning device 20, scanned, and converted into electronic form. This creates scanned document data 63, including graphics data.

The created scanned document data 63 is displayed, in scan preview mode, (on the display unit 29) in the control panel 26 of the PC 25 (step ST7). The scan preview may be displayed on the control panel 23 or on a display panel 66 in the main body 24 of the MFP 11.

The scanned document data 63 is examined on the control panel 26 (23) and accepted (step ST8) if no error is found. Then, for the addition of an electronic signature, the controller 35 calculates a hash value of the scanned document data 63 for communication purposes. The amount of scanned document data 63 to be sent is thus reduced.

The hash value of the scanned document data 63 is sent from the controller 35 of the MFP 11 to the electronic certificate server 15, where an electronic signature is given (step ST9), while being sent to the time-stamping server 14, where a time stamp is given.

After the hash value of the scanned document data 63 is given an electronic signature and time stamp, the scanned document data 63 is sent back to the controller 35, where the electronically signed (electronically certificated) and time-stamped hash value is attached to and combined with the scanned document data 63.

The time-stamped/electronically-signed scanned document data 64 is registered as a document image on the PC 25, and given a retrieval key for searching and viewing.

The time-stamped/electronically-signed scanned document data 64 with the retrieval key is sent to the document management server 13, which is given a search function, and stored on the document management server 13.

The time-stamped/electronically-signed scanned document data 64 stored on the document management server 13 with a search function can be retrieved by the client PC 12 with the use of the retrieval key.

The time-stamped/electronically-signed scanned document data 64 retrieved by the client PC 12 can be printed on a paper medium by the printing device 21 through the operation of the client PC 12. Since the scanned document data 64 is electronically signed and time-stamped, data tampering can be detected even if it occurs.

The scanned document data 63 created by the scanning device 20 is not accepted if any blurriness or defects are found therein (“No” in step ST8). Then, it is determined in step ST11 whether or not the original document is to be scanned by the scanning device 20 of the MFP 11 again. If the scanning operation of the scanning device 20 is to be performed again, the process returns to step ST3.

In step ST12, it is determined whether or not the scanning operation of the scanning device 20 is to continue. If it is determined that the scanning operation of the scanning device 20 is to continue, the process returns to step ST3 and the operations in steps ST3 to ST10 are repeated. If it is determined in step ST12 that the scanning operation of the scanning device 20 is not to continue, the scanning operation of the scanning device 20 ends.

In the document management system 10 of the embodiment described above, the MFP 11 is connected to the time-stamping server 14 and to the electronic certificate server 15 via the communication network 17, such as the Internet. However, the time-stamping server 14 and the electronic certificate server 15 may be installed within the company, and the MFP 11 is connected thereto via a LAN.

The degrees of importance of documents required to be kept under legal requirements and company's (private) rules vary. Therefore, documents with higher importance may be selected such that they are signed by the time-stamping server 14 and electronic certificate server 15 provided by (public) third-party organizations that are highly reliable.

What is claimed is:

1. A document management system comprising:
a scanning device for reading and converting a document image of a contract document, an approval document, a project proposal, a receipt or the like into electronic form to generated scanned document data;
a time-stamping server for adding a time stamp to the scanned document data;
a certificate server for adding an electronic signature to the scanned document data;
a document management server for receiving and storing the time-stamped and electronically signed scanned document data; and
a control panel for controlling scanning operation of the scanning device,
wherein a scan template for configuring scan settings for the scanning device is created on the control panel.

2. The document management system according to claim 1, wherein the control panel is included in a main body of the scanning device.

3. The document management system according to claim 1, wherein the scanning device is provided with a separate scan PC having a control panel, and scanning operation of the scanning device is performed by operating the control panel of the scan PC.

4. The document management system according to claim 1, wherein the scanning device is disposed integrally in an upper part of a multi-functional peripheral.

5. The document management system according to claim 1, wherein the control panel provides a certificate system for allowing only pre-registered users to operate the scanning device.

6. The document management system according to claim 1, wherein the control panel provides a plurality of scan buttons used to select a scan template reflecting setting items required for converting a document image into electronic form.

7. The document management system according to claim 1, wherein the control panel provides at least one scan template in which a scan setting item, a filing setting item, an optical character recognition setting item, and a security setting item are arranged.

8. A scan template created on a control panel of a scanning device, reflecting the operation of a plurality of scan buttons, and including setting items required for converting a document image into electronic form.

9. The scan template according to claim 8, wherein the setting items required for converting a document image into electronic form include at least a scan setting item, a filing setting item, an optical character recognition setting item, and a security setting item.

10. The scan template according to claim 8, wherein the plurality of scan buttons on the control panel are used to select the scan template including setting items required for converting a document image into electronic form.

11. The scan template according to claim 8, wherein the setting items to be displayed can be changed.
